(19) United States
(12) Patent Application Publication
(10) Pub. No.: US 2022/0338623 A1
(43) Pub. Date: Oct. 27, 2022

(54) LOCKER UNIT HAVING A SECURITY FEATURE

(71) Applicant: RACKIT LTD, Ayr (GB)

(72) Inventor: James Ferguson, Ayr (GB)

(73) Assignee: RACKIT LTD, Ayr (GB)

(21) Appl. No.: 17/760,825

(22) PCT Filed: Sep. 1, 2020
(86) PCT No.: PCT/GB2020/052081

§ 371 Date: Mar. 16, 2022

(30) Foreign Application Priority Data
Sep. 20, 2019 (GB) 1913630.8

(51) Int. Cl. A47B 47/02; E05G 1/024

(52) U.S. Cl. CPC A47B 47/025; E05G 1/024

(57) ABSTRACT

A locker unit comprising: a cabinet body; at least one internal mounting bracket (40) provided at each lateral side of the cabinet body; at least one horizontal panel (30) mountable to each mounting bracket (40) at a vertical height so as to define two or more vertically stacked lockers, each panel (30) comprising a side flange (32) provided at each lateral edge of the panel; and a door associated with each locker, wherein each side flange has one or more apertures which are alignable with an aperture provided at the mounting bracket for receiving a retaining member (42), and wherein each panel includes an obstructing member (50) located near to each aperture of the side flange.

The present invention relates to storage units in public spaces. In particular, but not exclusively, the present invention relates to locker units having improved security.

Many buildings such as airports, sports clubs, workplaces and so on provide locker units for people to store personal items. Often, a locker unit comprises a plurality of vertically stacked individual lockers. Each locker requires a specific key for unlocking and opening the locker.

The locker unit is usually a steel cabinet with horizontal panels that define the ceiling of one locker and the floor of the locker directly above. Each panel is mounted on a mounting bracket provided at each side of the locker unit. Each mounting bracket provides a hook portion for hanging the panel. Mounting pins extend through the mounting brackets and are received in apertures in the vertical side flanges of each panel for fixing the panel in place.

However, this can represent a security threat. If a person can insert a tool, such as a screwdriver, between the side flange of the panel and the hook portion of the mounting bracket, it can be possible to use the tool as a lever to bend the hook portion (inwards toward the interior of the locker unit) so that the panel separates from one of the mounting pins. If this is done for each of the four mounting pins then the panel can be lifted upwards and then removed. The person then has access to the vertically adjacent locker and any personal belongings that are present.

Many locker units are provided as flatpack units for assembly at the building or public space. The assembler will generally only have access to common tools. This limits the options for how the panels are secured within the cabinet body. For example, the panel will not be welded in place. However, if the locker unit can be assembled using common tools, it is more likely that it can be disassembled.

It is desirable to provide an improved locker unit which, once assembled, inhibits access to the mounting arrangement.

According to a first aspect of the present invention there is provided a locker unit comprising:
a cabinet body;
at least one internal mounting bracket provided at each lateral side of the cabinet body;
at least one horizontal panel mountable to each mounting bracket at a vertical height so as to define two or more vertically stacked lockers, each panel comprising a side flange provided at each lateral edge of the panel; and
a door associated with each locker,
wherein each side flange has one or more apertures which are alignable with an aperture provided at the mounting bracket for receiving a retaining member,
and wherein each panel includes an obstructing member located near to each aperture of the side flange.

Optionally, the obstructing member comprises a plate which is spaced apart and extends parallel to the side flange.

Optionally, the obstructing member comprises an L shaped plate.

Optionally, a first leg of the L shaped plate abuts and is fastened to a rear surface of the panel.

Optionally, the first leg is welded to the rear surface of the panel.

Optionally, the second leg of the L shaped plate is spaced apart and extends parallel to the side flange.

Optionally, each retaining member of each mounting bracket has a predetermined length such that it extends a predetermined distance into each aperture.

Optionally, the obstructing member is spaced apart from each aperture by a distance which is just greater than the predetermined distance of extension of each retaining member.

Optionally, each obstructing member extends for substantially the length of the panel.

Optionally, each mounting bracket comprises a hook portion for receiving a side flange of the panel.

Optionally, each mounting bracket comprises a ledge portion for supporting a side flange of a panel.

Optionally, a plurality of panels are provided, each at a particular vertical height for defining three or more individual lockers.

Optionally, the locker unit is provided in a disassembled or flatpack form for assembly in situ.

According to a second aspect of the present invention there is provided a disassembled locker unit comprising:
a plurality of panels which are connectable to form a cabinet body;
at least one internal mounting bracket which is locatable at each lateral side of the cabinet body;
at least one horizontal panel mountable to each mounting bracket at a vertical height so as to define two or more vertically stacked lockers, each panel comprising a side flange provided at each lateral edge of the panel; and
a door associated with each locker,
wherein each side flange has one or more apertures which are alignable with an aperture provided at the mounting bracket for receiving a retaining member,
and wherein each panel includes an obstructing member located near to each aperture of the side flange.

Optionally, the obstructing member comprises a plate which is spaced apart and extends parallel to the side flange.

Optionally, the obstructing member comprises an L shaped plate.

Optionally, a first leg of the L shaped plate abuts and is fastened to a rear surface of the panel.

Optionally, the first leg is welded to the rear surface of the panel.

Optionally, the second leg of the L shaped plate is spaced apart and extends parallel to the side flange.

Optionally, each retaining member of each mounting bracket has a predetermined length such that it extends a predetermined distance into each aperture.

Optionally, the obstructing member is spaced apart from each aperture by a distance which is just greater than the predetermined distance of extension of each retaining member.

Optionally, each obstructing member extends for substantially the length of the panel.

Optionally, each mounting bracket comprises a hook portion for receiving a side flange of the panel.

Optionally, each mounting bracket comprises a ledge portion for supporting a side flange of a panel.

Optionally, a plurality of panels are provided, each at a particular vertical height for defining three or more individual lockers.

The invention will be described below, by way of example only, with reference to the accompanying drawings, in which:

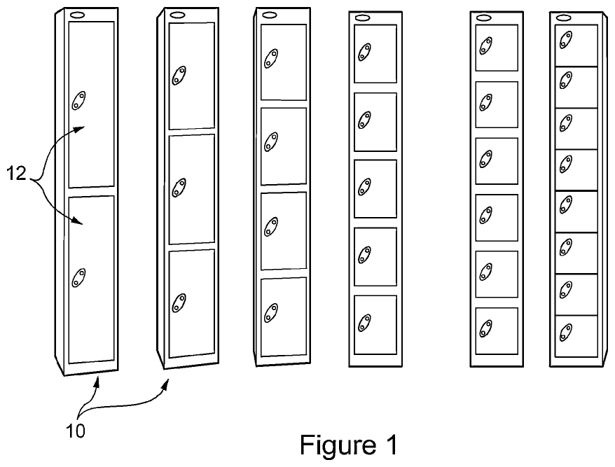

FIG. 1 is a front view of a range of assorted locker units;

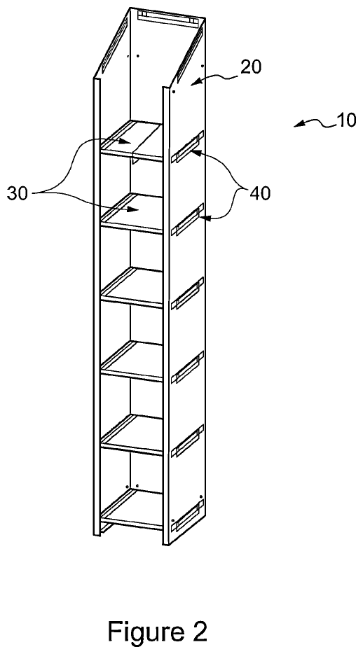

FIG. 2 is a perspective front view of the main body and panels of a locker unit in accordance with the present invention;

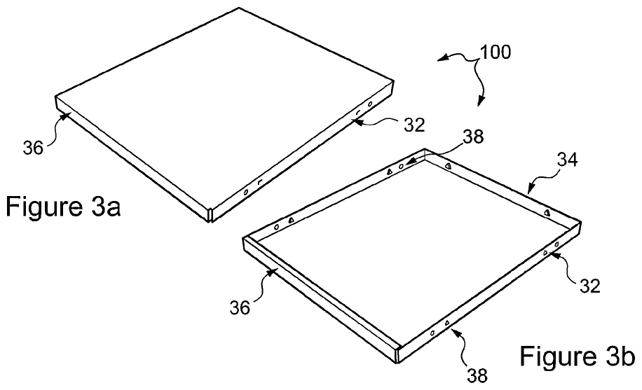

FIG. 3 is a perspective (a) top view and (b) rear view of a panel of a locker unit in accordance with the prior art; and

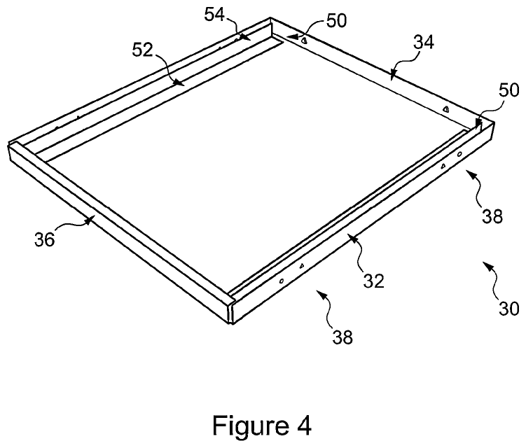

FIG. 4 is a perspective rear view of a panel of the locker unit of FIG. 2; and

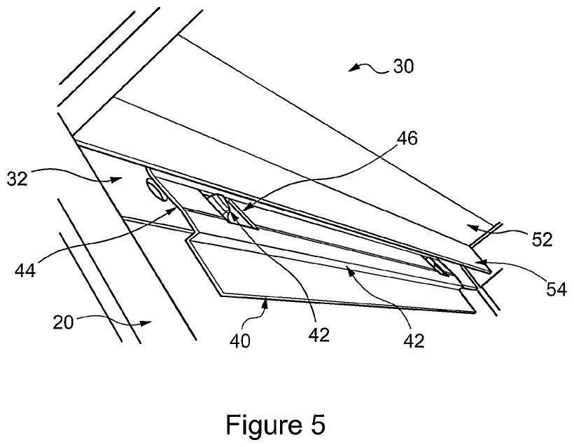

FIG. 5 is a detailed perspective view of a panel mounted on a mounting bracket for the locker unit of FIG. 2.

FIG. 1 shows a variety of locker units 10. Each locker unit 10 has at least two vertically stacked lockers 12.

FIG. 2 shows the main cabinet body 20 and panels 30 of a locker unit 10 in accordance with the present invention. In the figure, the doors and roof panel of the locker unit 10 are not shown.

Each panel 30 is mounted to a mounting bracket 40 provided at each lateral side of the body 20 at a vertical height so that the panel 30 defines two vertically stacked lockers 12. The panel 30 defines the ceiling of one locker 12 and the floor of the locker 12 directly above.

FIG. 3 shows a known panel 100 in accordance with the prior art. The panel 100 is formed from sheet metal which is bent to provide side flanges 32, a rear flange 34 and a front flange (which has a second bend to form a lip 36). Each side flange 32 has apertures 38 for receiving a retaining member 42 as explained below.

FIG. 4 shows a panel 30 in accordance with the present invention and like features are given like reference numerals. The panel 30 is the same as that of FIG. 3 except that it includes an obstructing member 50.

The obstructing member 50 comprises an L shaped plate. The obstructing member 50 has a suitable thickness such that it is relatively stiff. A first leg 52 of the L shaped plate abuts and is fastened by welding to a rear surface of the panel 30. The second leg 54 of the L shaped plate extends downwards. It is spaced apart and extends parallel to the side flange 32 for substantially the entire length (from front to rear) of the panel 30. Therefore, it is located near to each aperture 38 of the side flange 32.

FIG. 5 shows the panel 30 mounted in a mounting bracket 40. The bracket 40 is twice bent to form a horizontal ledge 42 for supporting the side flange 32 of the panel 30. This also defines a hook portion 44 for receiving the side flange 32. The side flange 32 can slide downwards during assembly in the gap between the side of the body 20 and the hook portion 44 until it abuts the ledge 42.

Apertures 38 of the side flange 32 align with apertures 46 of the mounting bracket 40 when the panel 30 is in position. A retaining member 42 extends through these apertures so that the panel 30 can no longer be lifted upwards and clear of the mounting bracket 40.

Each retaining member 42 has a predetermined length such that it extends a predetermined distance through the apertures. However, the obstructing member 50 is spaced apart from the apertures by a distance which is just greater than this predetermined distance of extension of the retaining member 42.

When assembled, the panel 30 is fixed in position. In a prior art assembly, a person could insert a tool between the side flange 32 and the hook portion 44 to bend the hook portion inwards until it is clear of the retaining member 42. The panel 30 could then be lifted upwards and removed, giving access to the vertically adjacent locker 12.

However, with the locker unit 10 of the invention, the obstructing member 50 provides a stop to limit the possible amount of bending of the hook portion 44. The obstructing member 50 is sufficiently close to the hook portion 44 such that it cannot be separated from the retaining member 42 in this manner.

Due to its shape and thickness, the L shaped obstructing member 50 is sufficiently stiff such that the obstructing member 50 itself cannot be easily bent using hand tools.

The locker unit of the invention can be provided in a flatpack form for assembly on site. Once assembled, the obstructing member 50 inhibits access to the mounting arrangement to provide greater security.

Various modifications and improvements can be made to the above without departing from the scope of the invention.

1-20. (canceled)

21. A locker unit comprising:
a cabinet body;
at least one internal mounting bracket provided at each lateral side of the cabinet body;
at least one horizontal panel mountable to each mounting bracket at a vertical height so as to define two or more vertically stacked lockers, each panel comprising a side flange provided at each lateral edge of the panel; and
a door associated with each locker;
wherein each side flange has one or more apertures which are alignable with an aperture provided at the mounting bracket for receiving a retaining member;
wherein each panel includes an obstructing member located near to each aperture of the side flange; and
wherein the obstructing member comprises a plate which is spaced apart and extends parallel to the side flange.

22. The locker unit as claimed in claim 21, wherein the obstructing member comprises an L shaped plate.

23. The locker unit as claimed in claim 22, wherein a first leg of the L shaped plate abuts and is fastened to a rear surface of the panel.

24. The locker unit as claimed in claim 22, wherein the second leg of the L shaped plate is spaced apart and extends parallel to the side flange.

25. The locker unit as claimed in claim 21, wherein each retaining member of each mounting bracket has a predetermined length such that it extends a predetermined distance into each aperture.

26. The locker unit as claimed in claim 21, wherein the obstructing member is spaced apart from each aperture by a distance which is just greater than the predetermined distance of extension of each retaining member.

27. The locker unit as claimed in claim 21, wherein each obstructing member extends for substantially the length of the panel.

28. The locker unit as claimed in claim 21, wherein each mounting bracket comprises a hook portion for receiving a side flange of the panel.

29. The locker unit as claimed in claim 21, wherein each mounting bracket comprises a ledge portion for supporting a side flange of a panel.

30. The locker unit as claimed in claim 21, wherein a plurality of panels are provided, each at a particular vertical height for defining three or more individual lockers.

31. A disassembled locker unit comprising:
a plurality of panels which are connectable to form a cabinet body;
at least one internal mounting bracket which is locatable at each lateral side of the cabinet body;
at least one horizontal panel mountable to each mounting bracket at a vertical height so as to define two or more vertically stacked lockers, each panel comprising a side flange provided at each lateral edge of the panel;
a door associated with each locker;
wherein each side flange has one or more apertures which are alignable with an aperture provided at the mounting bracket for receiving a retaining member;
wherein each panel includes an obstructing member located near to each aperture of the side flange; and
wherein the obstructing member comprises a plate which is spaced apart and extends parallel to the side flange.

32. The locker unit as claimed in claim 31, wherein the obstructing member comprises an L shaped plate.

33. The locker unit as claimed in claim 32, wherein a first leg of the L shaped plate abuts and is fastened to a rear surface of the panel.

34. The locker unit as claimed in claim 32, wherein the second leg of the L shaped plate is spaced apart and extends parallel to the side flange.

35. The locker unit as claimed in claim 31, wherein each retaining member of each mounting bracket has a predetermined length such that it extends a predetermined distance into each aperture.

36. The locker unit as claimed in claim 35, wherein the obstructing member is spaced apart from each aperture by a distance which is just greater than the predetermined distance of extension of each retaining member.

37. The locker unit as claimed in claim 31, wherein each mounting bracket comprises a hook portion for receiving a side flange of the panel.

38. The locker unit as claimed in claim 31, wherein each mounting bracket comprises a ledge portion for supporting a side flange of a panel.
